(19) United States
(12) Patent Application Publication
(10) Pub. No.: US 2003/0163320 A1
(43) Pub. Date: Aug. 28, 2003

(54) Voice synthesis device

(76) Inventors: Nobuhide Yamazaki, Kanagawa (JP); Kenichiro Kobayashi, Kanagawa (JP); Yasuharu Asano, Kanagawa (JP); Shinichi Kariya, Kanagawa (JP); Yaeko Fuita, Tokyo (JP)

Correspondence Address: William S Frommer, Frommer Lawrence & Haug, 745 Fifth Avenue, New York, NY, 10151, US

(21) Appl. No.: 10/275,325

(22) PCT Filed: Mar. 8, 2002
(86) PCT No.: PCT/JP02/02176

(30) Foreign Application Priority Data
Mar. 9, 2001 (JP) 2001-66376

(51) Int. Cl. G10L 11/00

(52) U.S. Cl. 704/270

(57) ABSTRACT

The present invention relates to a speech synthesis apparatus for generating an emotionally expressive synthesized voice. The emotionally expressive synthesized voice can be generated by generating a synthesized voice with a tone being changed in accordance with an emotional state. A parameter generator 43 generates transform parameters and synthesis control parameters on the basis of state information indicating the emotional state of a pet robot. A data transformer 44 transforms the frequency characteristics of phonemic unit data as speech information. A waveform generator 42 obtains necessary phonemic unit data on the basis of phoneme information included in a text analysis result, processes and connects the phonemic unit data with one another on the basis of prosody data and the synthesis control parameters, and generates synthesized voice data with the corresponding prosody and tone. The present invention is applicable to robots for outputting synthesized voices.

### TECHNICAL FIELD

The present invention relates to speech synthesis apparatuses, and more particularly relates to a speech synthesis apparatus capable of generating an emotionally expressive synthesized voice.

### BACKGROUND ART

In known speech synthesis apparatuses, text or a phonetic alphabet character is given thereto to generate a corresponding synthesized voice.

Recently, for example, as a pet-type pet robot, a pet robot with a speech synthesis apparatus capable of talking to a user has been proposed.

As another type of pet robot, a pet robot which uses an emotion model representing an emotional state and which obeys/disobeys a command given by a user in accordance with the emotional state represented by the emotion model has been proposed.

If the tone of the synthesized voice can be changed in accordance with the emotion model, a synthesized voice with a tone in accordance with the emotion can be output. Thus, the pet robot becomes more entertaining.

### DISCLOSURE OF INVENTION

In view of the foregoing circumstances, it is an object of the present invention to produce an emotionally expressive synthesized voice by generating a synthesized voice having a variable tone depending on an emotional state.

A speech synthesis apparatus of the present invention includes tone-influencing information generating means for generating, among predetermined information, tone-influencing information for influencing the tone of a synthesized voice on the basis of externally-supplied state information indicating an emotional state; and speech synthesis means for generating the synthesized voice with a tone controlled using the tone-influencing information.

A speech synthesis method of the present invention includes a tone-influencing information generating step of generating, among predetermined information, tone-influencing information for influencing the tone of a synthesized voice on the basis of externally-supplied state information indicating an emotional state; and a speech synthesis step of generating the synthesized voice with a tone controlled using the tone-influencing information.

A program of the present invention includes a tone-influencing information generating step of generating, among predetermined information, tone-influencing information for influencing the tone of a synthesized voice on the basis of externally-supplied state information indicating an emotional state; and a speech synthesis step of generating the synthesized voice with a tone controlled using the tone-influencing information.

A recording medium of the present invention has a program recorded therein, the program including a tone-influencing information generating step of generating, among predetermined information, tone-influencing information for influencing the tone of a synthesized voice on the basis of externally-supplied state information indicating an emotional state; and a speech synthesis step of generating the synthesized voice with a tone controlled using the tone-influencing information.

According to the present invention, among predetermined information, tone-influencing information for influencing the tone of a synthesized voice is generated on the basis of externally-supplied state information indicating an emotional state. The synthesized voice with a tone controlled using the tone-influencing information is generated.

### BRIEF DESCRIPTION OF THE DRAWINGS

FIG. 1 is a perspective view showing an example of the external configuration of an embodiment of a robot to which the present invention is applied.

FIG. 2 is a block diagram showing an example of the internal configuration of the robot.

FIG. 3 is a block diagram showing an example of the functional configuration of a controller 10.

FIG. 4 is a block diagram showing an example of the configuration of a speech recognition unit 50A.

FIG. 5 is a block diagram showing an example of the configuration of a speech synthesizer 55.

FIG. 6 is a block diagram showing an example of the configuration of a rule-based synthesizer 32.

FIG. 7 is a flowchart describing a process performed by the rule-based synthesizer 32.

FIG. 8 is a block diagram showing a first example of the configuration of a waveform generator 42.

FIG. 9 is a block diagram showing a first example of the configuration of a data transformer 44.

FIG. 10A is an illustration of characteristics of a higher frequency emphasis filter.

FIG. 10B is an illustration of characteristics of a higher frequency suppressing filter.

FIG. 11 is a block diagram showing a second example of the configuration of the waveform generator 42.

FIG. 12 is a block diagram showing a second example of the configuration of the data transformer 44.

FIG. 13 is a block diagram showing an example of the configuration of an embodiment of a computer to which the present invention is applied.

### BEST MODE FOR CARRYING OUT THE INVENTION

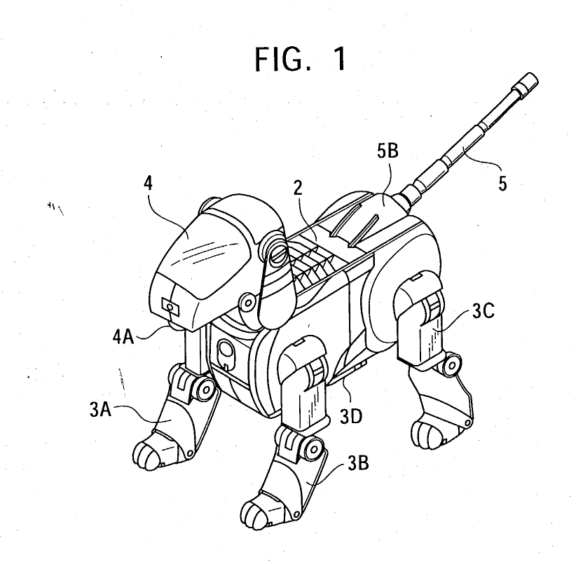

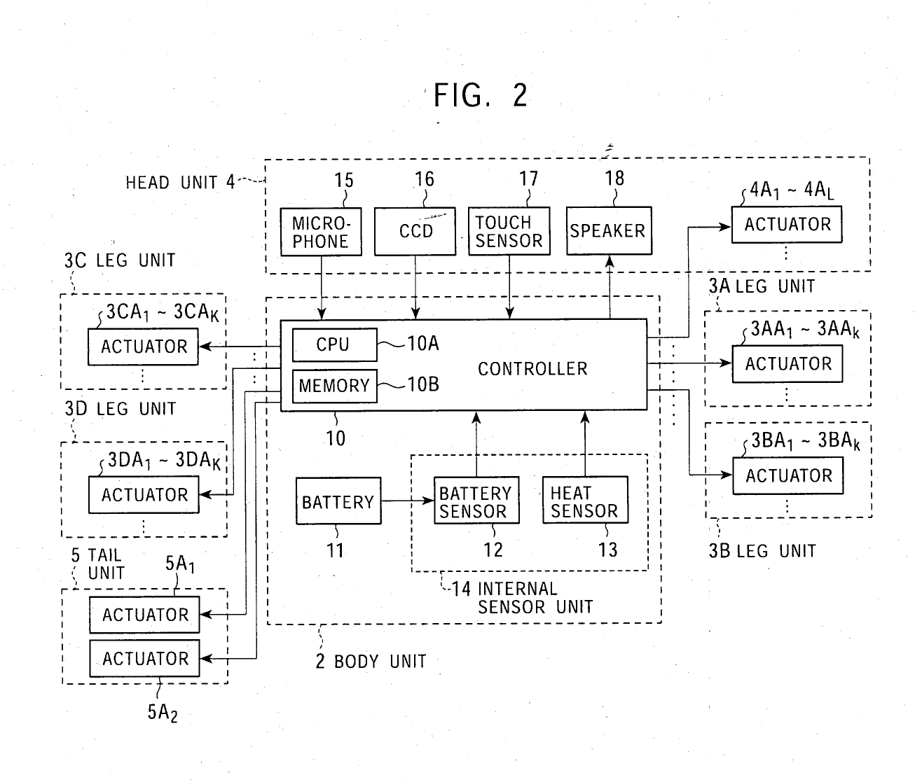

FIG. 1 shows an example of the external configuration of an embodiment of a robot to which the present invention is applied, and FIG. 2 shows an example of the electrical configuration of the same.

In this embodiment, the robot has the form of a four-legged animal such as a dog. Leg units 3A, 3B, 3C, and 3D are connected to the front, back, left and right of a body unit 2. Also, a head unit 4 and a tail unit 5 are connected to the body unit 2 at the front and at the rear, respectively.

The tail unit 5 is extended from a base unit 5B provided on the top surface of the body unit 2, and the tail unit 5 is extended so as to bend or swing with two degree of freedom.

The body unit 2 includes therein a controller 10 for controlling the overall robot, a battery 11 as a power source of the robot, and an internal sensor unit 14 including a battery sensor 12 and a heat sensor 13.

The head unit 4 is provided with a microphone 15 that corresponds to “ears”, a CCD (Charge Coupled Device) camera 16 that corresponds to “eyes”, a touch sensor 17 that corresponds to a touch receptor, and a speaker 18 that corresponds to a “mouth”, at respective predetermined locations. Also, the head unit 4 is provided with a lower jaw 4A which corresponds to a lower jaw of the mouth and which can move with one degree of freedom. The lower jaw 4A is moved to open/shut the robot's mouth.

As shown in FIG. 2, the joints of the leg units 3A to 3D, the joints between the leg units 3A to 3D and the body unit 2, the joint between the head unit 4 and the body unit 2, the joint between the head unit 4 and the lower jaw 4A, and the joint between the tail unit 5 and the body unit 2 are provided with actuators 3AA₁ to 3AA_{K}, 3BA₁ to 3BA_{K}, 3CA₁ to 3CA_{K}, 3DA₁ to 3DA_{K}, 4A₁ to 4A_{L}, 5A₁, and 5A₂, respectively.

The microphone 15 of the head unit 4 collects ambient speech (sounds) including the speech of a user and sends the obtained speech signals to the controller 10. The CCD camera 16 captures an image of the surrounding environment and sends the obtained image signal to the controller 10.

The touch sensor 17 is provided on, for example, the top of the head unit 4. The touch sensor 17 detects pressure applied by a physical contact, such as “patting” or “hitting” by the user, and sends the detection result as a pressure detection signal to the controller 10.

The battery sensor 12 of the body unit 2 detects the power remaining in the battery 11 and sends the detection result as a battery remaining power detection signal to the controller 10. The heat sensor 13 detects heat in the robot and sends the detection result as a heat detection signal to the controller 10.

The controller 10 includes therein a CPU (Central Processing Unit) 10A, a memory 10B, and the like. The CPU 10A executes a control program stored in the memory 10B to perform various processes.

Specifically, the controller 10 determines the characteristics of the environment, whether a command has been given by the user, or whether the user has approached, on the basis of the speech signal, the image signal, the pressure detection signal, the battery remaining power detection signal, and the heat detection signal, supplied from the microphone 15, the CCD camera 16, the touch sensor 17, the battery sensor 12, and the heat sensor 13, respectively.

On the basis of the determination result, the controller 10 determines subsequent actions to be taken. On the basis of the action determination result, the controller 10 activates necessary units among the actuators 3AA₁, to 3AA_{K}, 3BA₁ to 3BA_{K}, 3CA₁ to 3CA_{K}, 3DA₁ to 3DA_{K}, 4A₁ to 4A_{L}, 5A₁, and 5A₂. This causes the head unit 4 to sway vertically and horizontally and the lower jaw 4A to open and shut. Furthermore, this causes the tail unit 5 to move and activates the leg units 3A to 3D to cause the robot to walk.

As circumstances demand, the controller 10 generates a synthesized voice and supplies the generated sound to the speaker 18 to output the sound. In addition, the controller 10 causes an LED (Light Emitting Diode) (not shown) provided at the position of the “eyes” of the robot to turn on, turn off, or flash on and off.

Accordingly, the robot is configured to behave autonomously on the basis of the surrounding states and the like.

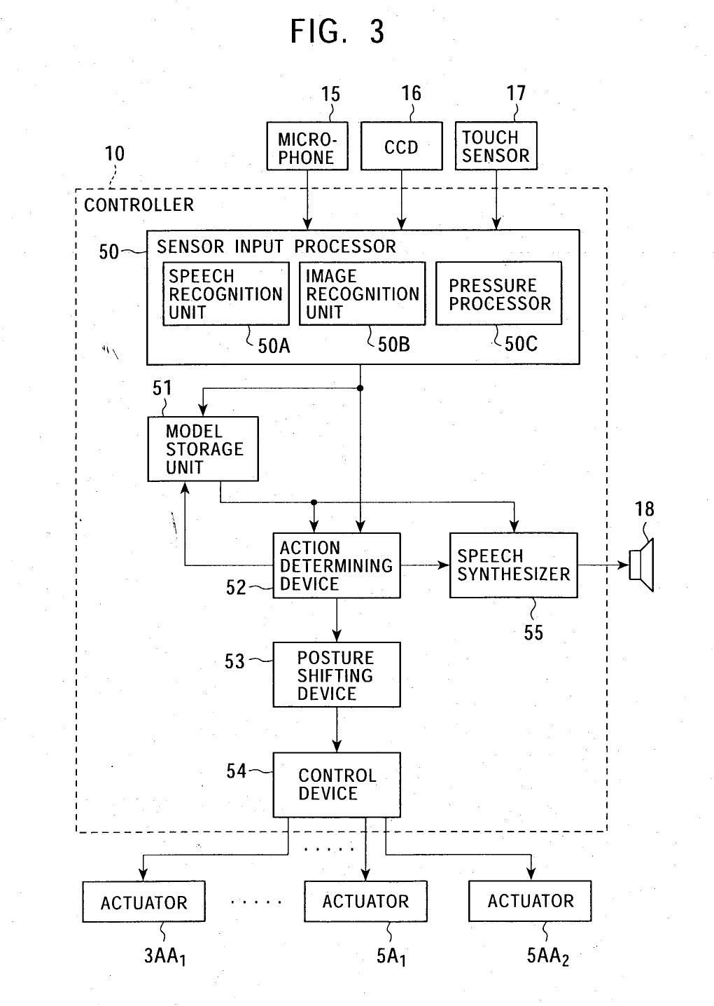

FIG. 3 shows an example of the functional configuration of the controller 10 shown in FIG. 2. The functional configuration shown in FIG. 3 is implemented by the CPU 10A executing the control program stored in the memory 10B.

The controller 10 includes a sensor input processor 50 for recognizing a specific external state; a model storage unit 51 for accumulating recognition results obtained by the sensor input processor 50 and expressing emotional, instinctual, and growth states; an action determining device 52 for determining subsequent actions on the basis of the recognition results obtained by the sensor input processor 50; a posture shifting device 53 for causing the robot to actually perform an action on the basis of the determination result obtained by the action determining device 52; a control device 54 for driving and controlling the actuators 3AA₁ to 5A₁ and 5A₂; and a speech synthesizer 55 for generating a synthesized voice.

The sensor input processor 50 recognizes a specific external state, a specific approach made by the user, and a command given by the user on the basis of the speech signal, the image signal, the pressure detection signal, and the like supplied from the microphone 15, the CCD camera 16, the touch sensor 17, and the like, and informs the model storage unit 51 and the action determining device 52 of state recognition information indicating the recognition result.

More specifically, the sensor input processor 50 includes a speech recognition unit 50A. The speech recognition unit 50A performs speech recognition of the speech signal supplied from the microphone 15. The speech recognition unit 50A reports the speech recognition result, which is a command, such as “walk”, “down”, “chase the ball”, or the like, as the state recognition information to the model storage unit 51 and the action determining device 52.

The sensor input processor 50 includes an image recognition unit 50B. The image recognition unit 50B performs image recognition processing using the image signal supplied from the CCD camera 16. When the image recognition unit 50B resultantly detects, for example, “a red, round object” or “a plane perpendicular to the ground of a predetermined height or greater”, the image recognition unit 50B reports the image recognition result such that “there is a ball” or “there is a wall” as the state recognition information to the model storage unit 51 and the action determining device 52.

Furthermore, the sensor input processor 50 includes a pressure processor 50C. The pressure processor 50C processes the pressure detection signal supplied from the touch sensor 17. When the pressure processor 50C resultantly detects pressure which exceeds a predetermined threshold and which is applied in a short period of time, the pressure processor 50C recognizes that the robot has been “hit (punished)”. When the pressure processor 50C detects pressure which falls below a predetermined threshold and which is applied over a long period of time, the pressure processor 50C recognizes that the robot has been “patted (rewarded)”. The pressure processor 50C reports the recognition result as the state recognition information to the model storage unit 51 and the action determining device 52.

The model storage unit 51 stores and manages emotion models, instinct models, and growth models for expressing emotional, instinctual, and growth states, respectively.

The emotion models represent emotional states (degrees) such as, for example, “happiness”, “sadness”, “anger”, and “enjoyment” using values within a predetermined range (for example, −1.0 to 1.0). The values are changed on the basis of the state recognition information from the sensor input processor 50, the elapsed time, and the like. The instinct models represent desire states (degrees) such as “hunger”, “sleep”, “movement”, and the like using values within a predetermined range. The values are changed on the basis of the state recognition information from the sensor input processor 50, the elapsed time, and the like. The growth models represent growth states (degrees) such as “childhood”, “adolescence”, “mature age”, “old age”, and the like using values within a predetermined range. The values are changed on the basis of the state recognition information from the sensor input processor 50, the elapsed time, and the like.

In this manner, the model storage unit 51 outputs the emotional, instinctual, and growth states represented by values of the emotion models, instinct models, and growth models, respectively, as state information to the action determining device 52.

The state recognition information is supplied from the sensor input processor 50 to the model storage unit 51. Also, action information indicating the contents of present or past actions taken by the robot, for example, “walked for a long period of time”, is supplied from the action determining device 52 to the model storage unit 51. Even if the same state recognition information is supplied, the model storage unit 51 generates different state information in accordance with robot's actions indicated by the action information.

More specifically, for example, if the robot says hello to the user and the robot is patted on the head by the user, action information indicating that the robot says hello to the user and state recognition information indicating that the robot is patted on the head are supplied to the model storage unit 51. In this case, the value of the emotion model representing “happiness” increases in the model storage unit 51.

In contrast, if the robot is patted on the head while performing a particular task, action information indicating that the robot is currently performing the task and state recognition information indicating that the robot is patted on the head are supplied to the model storage unit 51. In this case, the value of the emotion model representing “happiness” does not change in the model storage unit 51.

The model storage unit 51 sets the value of the emotion model by referring to the state recognition information and the action information indicating the present or past actions taken by the robot. Thus, when the user pats the robot on the head to tease the robot while the robot is performing a particular task, an unnatural change in emotion such as an increase in the value of the emotion model representing “happiness” is prevented.

As in the emotion models, the model storage unit 51 increases or decreases the values of the instinct models and the growth models on the basis of both the state recognition information and the action information. Also, the model storage unit 51 increases or decreases the values of the emotion models, instinct models, or growth models on the basis of the values of the other models.

The action determining device 52 determines subsequent actions on the basis of the state recognition information supplied from the sensor input processor 50, the state information supplied from the model storage unit 51, the elapsed time, and the like, and sends the contents of the determined action as action command information to the posture shifting device 53.

Specifically, the action determining device 52 manages a finite state automaton in which actions which may be taken by the robot are associated with states as an action model for defining the actions of the robot. A state in the finite state automaton as the action model undergoes a transition on the basis of the state recognition information from the sensor input processor 50, the values of the emotion models, the instinct models, or the growth models in the model storage unit 51, the elapsed time, and the like. The action determining device 52 then determines an action that corresponds to the state after the transition as the subsequent action.

If the action determining device 52 detects a predetermined trigger, the action determining device 52 causes the state to undergo a transition. In other words, the action determining device 52 causes the state to undergo a transition when the action that corresponds to the current state has been performed for a predetermined period of time, when predetermined state recognition information is received, or when the value of the emotional, instinctual, or growth state indicated by the state information supplied from the model storage unit 51 becomes less than or equal to a predetermined threshold or becomes greater than or equal to the predetermined threshold.

As described above, the action determining device 52 causes the state in the action model to undergo a transition based not only on the state recognition information from the sensor input processor 50 but also on the values of the emotion models, the instinct models, and the growth models in the model storage unit 51, and the like. Even if the same state recognition information is input, the next state differs according to the values of the emotion models, the instinct models, and the growth models (state information).

As a result, for example, when the state information indicates that the robot is “not angry” and “not hungry”, and when the state recognition information indicates that “a hand is extended in front of the robot”, the action determining device 52 generates action command information that instructs the robot to “shake a paw” in response to the fact that the hand is extended in front of the robot. The action determining device 52 transmits the generated action command information to the posture shifting device 53.

When the state information indicates that the robot is “not angry” and “hungry”, and when the state recognition information indicates that “a hand is extended in front of the robot”, the action determining device 52 generates action command information that instructs the robot to “lick the hand” in response to the fact that the hand is extended in front of the robot. The action determining device 52 transmits the generated action command information to the posture shifting device 53.

For example, when the state information indicates the robot is “angry”, and when the state recognition information indicates that “a hand is extended in front of the robot”, the action determining device 52 generates action command information that instructs the robot to “turn the robot's head away” regardless of the state information indicating that the robot is “hungry” or “not hungry”. The action determining device 52 transmits the generated action command information to the posture shifting device 53.

The action determining device 52 can determine the walking speed, the magnitude and speed of the leg movement, and the like, which are parameters of the action that corresponds to the next state, on the basis of the emotional, instinctual, and growth states indicated by the state information supplied from the model storage unit 51. In this case, the action command information including the parameters is transmitted to the posture shifting device 53.

As described above, the action determining device 52 generates not only the action command information that instructs the robot to move its head and legs but also action command information that instructs the robot to speak. The action command information that instructs the robot to speak is supplied to the speech synthesizer 55. The action command information supplied to the speech synthesizer 55 includes text that corresponds to a synthesized voice to be generated by the speech synthesizer 55. In response to the action command information from the action determining device 52, the speech synthesizer 55 generates a synthesized voice on the basis of the text included in the action command information. The synthesized voice is supplied to the speaker 18 and is output from the speaker 18. Thus, the speaker 18 outputs the robot's voice, various requests such as “I'm hungry” to the user, responses such as “what?” in response to user's verbal contact, and other speeches. The state information is to be supplied from the model storage unit 51 to the speech synthesizer 55. The speech synthesizer 55 can generate a tone-controlled synthesized voice on the basis of the emotional state represented by this state information. Also, the speech synthesizer 55 can generate a tone-controlled synthesized voice on the basis of the emotional, instinctual, and growth states.

The posture shifting device 53 generates posture shifting information for causing the robot to move from the current posture to the next posture on the basis of the action command information supplied from the action determining device 52 and transmits the posture shifting information to the control device 54.

The next state which the current state can change to is determined on the basis of the shape of the body and legs, weight, physical shape of the robot such as the connection state between portions, and the mechanism of the actuators 3AA₁ to 5A₁ and 5A₂ such as the bending direction and angle of the joint.

The next state includes a state to which the current state can directly change and a state to which the current state cannot directly change. For example, although the four-legged robot can directly change to a down state from a lying state in which the robot sprawls out its legs, the robot cannot directly change to a standing state. The robot is required to perform a two-step action. First, the robot lies down on the ground with its limbs pulled toward the body, and then the robot stands up. Also, there are some postures that the robot cannot reliably assume. For example, if the four-legged robot which is currently in a standing position tries to hold up its front paws, the robot easily falls down.

The posture shifting device 53 stores in advance postures that the robot can directly change to. If the action command information supplied from the action determining device 52 indicates a posture that the robot can directly change to, the posture shifting device 53 transmits the action command information as posture shifting information to the control device 54. In contrast, if the action command information indicates a posture that the robot cannot directly change to, the posture shifting device 53 generates posture shifting information that causes the robot to first assume a posture that the robot can directly change to and then to assume the target posture and transmits the posture shifting information to the control device 54. Accordingly, the robot is prevented from forcing itself to assume an impossible posture or from falling down.

The control device 54 generates control signals for driving the actuators 3AA₁ to 5A₁ and 5A₂ in accordance with the posture shifting information supplied from the posture shifting device 53 and sends the control signals to the actuators 3AA₁ to 5A₁ and 5A₂. Therefore, the actuators 3AA₁ to 5A₁ and 5A₂ are driven in accordance with the control signals, and hence, the robot autonomously executes the action.

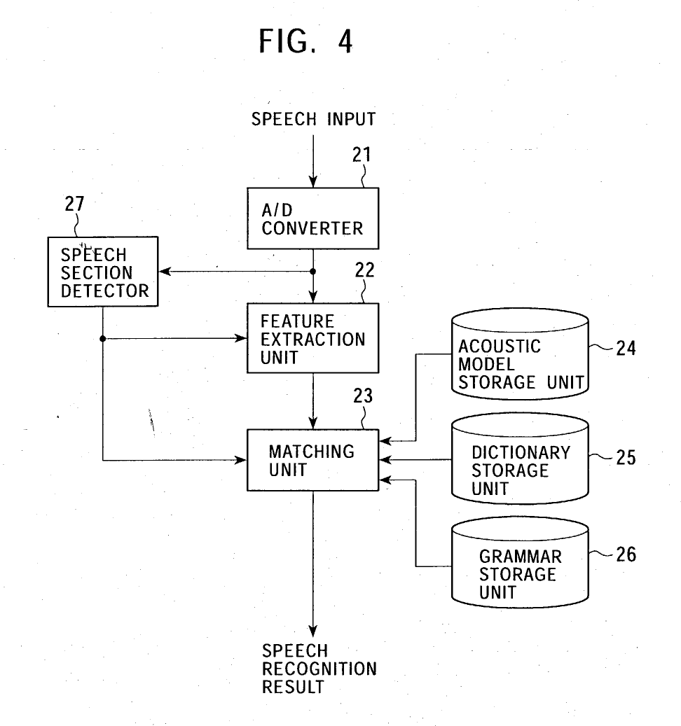

FIG. 4 shows an example of the configuration of the speech recognition unit 50A shown in FIG. 3.

A speech signal from the microphone 15 is supplied to an AD (Analog Digital) converter 21. The AD converter 21 samples the speech signal, which is an analog signal supplied from the microphone 15, and quantizes the sampled speech signal, thereby AD-converting the signal into speech data, which is a digital signal. The speech data is supplied to a feature extraction unit 22 and a speech section detector 27.

The feature extraction unit 22 performs, for example, an MFCC (Mel Frequency Cepstrum Coefficient) analysis of the speech data, which is input thereto, in units of appropriate frames and outputs MFCCs which are obtained as a result of the analysis as feature parameters (feature vectors) to a matching unit 23. Also, the feature extraction unit 22 can extract, as feature parameters, linear prediction coefficients, cepstrum coefficients, line spectrum pairs, and power in each predetermined frequency band (output of a filter bank).

Using the feature parameters supplied from the feature extraction unit 22, the matching unit 23 performs speech recognition of the speech (input speech) input to the microphone 15 on the basis of, for example, a continuously-distributed HMM (Hidden Markov Model) method by referring to the acoustic model storage unit 24, the dictionary storage unit 25, and the grammar storage unit 26 if necessary.

Specifically, the acoustic model storage unit 24 stores an acoustic model indicating acoustic features of each phoneme or each syllable in the language of speech which is subjected to speech recognition. For example, speech recognition is performed on the basis of the continuously-distributed HMM method. The HMM (Hidden Markov Model) is used as the acoustic model. The dictionary storage unit 25 stores a word dictionary that contains information (phoneme information) concerning the pronunciation of each word to be recognized. The grammar storage unit 26 stores grammar rules describing how words registered in the word dictionary of the dictionary storage unit 25 are concatenated (linked). For example, context-free grammar (CFG) or a rule based on statistical word concatenation probability (N-gram) can be used as the grammar rule.

The matching unit 23 refers to the word dictionary of the dictionary storage unit 25 to connect the acoustic models stored in the acoustic model storage unit 24, thus forming the acoustic model (word model) for a word. The matching unit 23 also refers to the grammar rule stored in the grammar storage unit 26 to connect several word models and uses the connected word models to recognize speech input via the microphone 15 on the basis of the feature parameters by using the continuously-distributed HMM method. In other words, the matching unit 23 detects a sequence of word models with the highest score (likelihood) of the time-series feature parameters being observed, which are output by the feature extraction unit 22. The matching unit 23 outputs phoneme information (pronunciation) on a word string that corresponds to the sequence of word models as the speech recognition result.

More specifically, the matching unit 23 accumulates the probability of each feature parameter occurring with respect to the word string that corresponds to the connected word models and assumes the accumulated value as a score. The matching unit 23 outputs phoneme information on the word string that has the highest score as the speech recognition result.

The recognition result of the speech input to the microphone 15, which is output as described above, is output as state recognition information to the model storage unit 51 and to the action determining device 52.

With respect to the speech data from the AD converter 21, the speech section detector 27 computes power in each frame as in the MFCC analysis performed by the feature extraction unit 22. Furthermore, the speech section detector 27 compares the power in each frame with a predetermined threshold and detects a section formed by a frame having power which is greater than or equal to the threshold as a speech section in which the user's speech is input. The speech section detector 27 supplies the detected speech section to the feature extraction unit 22 and the matching unit 23. The feature extraction unit 22 and the matching unit 23 perform processing of only the speech section. The detection method for detecting the speech section, which is performed by the speech section detector 27, is not limited to the above-described method in which the power is compared with the threshold.

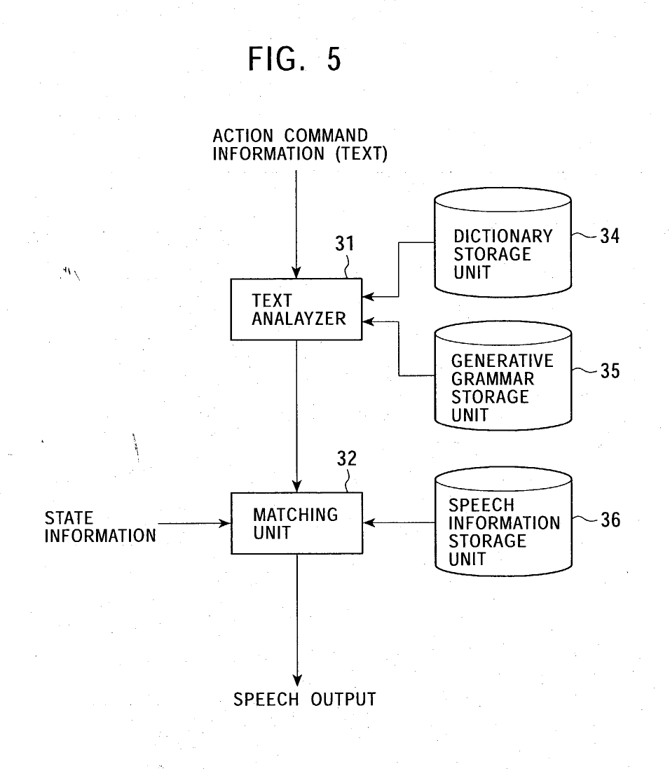

FIG. 5 shows an example of the configuration of the speech synthesizer 55 shown in FIG. 3.

Action command information including text which is subjected to speech synthesis and which is output from the action determining device 52 is supplied to a text analyzer 31. The text analyzer 31 refers to the dictionary storage unit 34 and a generative grammar storage unit 35 and analyzes the text included in the action command information.

Specifically, the dictionary storage unit 34 stores a word dictionary including parts-of-speech information, pronunciation information, and accent information on each word. The generative grammar storage unit 35 stores generative grammar rules such as restrictions on word concatenation about each word included in the word dictionary of the dictionary storage unit 34. On the basis of the word dictionary and the generative grammar rules, the text analyzer 31 performs text analysis (language analysis) such as morphological analysis and parsing syntactic analysis of the input text. The text analyzer 31 extracts information necessary for rule-based speech synthesis performed by a rule-based synthesizer 32 at the subsequent stage. The information required for rule-based speech synthesis includes, for example, prosody information for controlling the positions of pauses, accents, and intonation and phonemic information indicating the pronunciation of each word.

The information obtained by the text analyzer 31 is supplied to the rule-based synthesizer 32. The rule-based synthesizer 32 refers to a speech information storage unit 36 and generates speech data (digital data) on a synthesized voice which corresponds to the text input to the text analyzer 31.

Specifically, the speech information storage unit 36 stores, as speech information, phonemic unit data in the form of CV (Consonant and Vowel), VCV, CVC, and waveform data such as one-pitch. On the basis of the information from the text analyzer 31, the rule-based synthesizer 32 connects necessary phonemic unit data and processes the waveform of the phonemic unit data, thus appropriately adding pauses, accents, and intonation. Accordingly, the rule-based synthesizer 32 generates speech data for a synthesized voice (synthesized voice data) corresponding to the text input to the text analyzer 31. Alternatively, the speech information storage unit 36 stores speech feature parameters as speech information, such as linear prediction coefficients (LPC) and cepstrum coefficients, which are obtained by analyzing the acoustics of the waveform data. On the basis of the information from the text analyzer 31, the rule-based synthesizer 32 uses necessary feature parameters as tap coefficients for a synthesis filter for speech synthesis and controls a sound source for outputting a driving signal to be supplied to the synthesis filter, thus appropriately adding pauses, accents, and intonation. Accordingly, the rule-based synthesizer 32 generates speech data for a synthesized voice (synthesized voice data) corresponding to the text input to the text analyzer 31.

Furthermore, state information is supplied from the model storage unit 51 to the rule-based synthesizer 32. On the basis of, for example, the value of an emotion model among the state information, the rule-based synthesizer 32 generates tone-controlled information or various synthesis control parameters for controlling rule-based speech synthesis from the speech information stored in the speech information storage unit 36. Accordingly, the rule-based synthesizer 32 generates tone-controlled synthesized voice data.

The synthesized voice data generated in the above manner is supplied to the speaker 18, and the speaker 18 outputs a synthesized voice corresponding to the text input to the text analyzer 31 while controlling the tone in accordance with the emotion.

As described above, the action determining device 52 shown in FIG. 3 determines subsequent actions on the basis of the action model. The contents of the text to be output as the synthesized voice can be associated with the actions taken by the robot.

Specifically, for example, when the robot executes an action of changing from a sitting state to a standing state, the text “alley-oop!” can be associated with the action. In this case, when the robot changes from the sitting state to the standing state, the synthesized voice “alley-oop!” can be output in synchronization with the change in the posture.

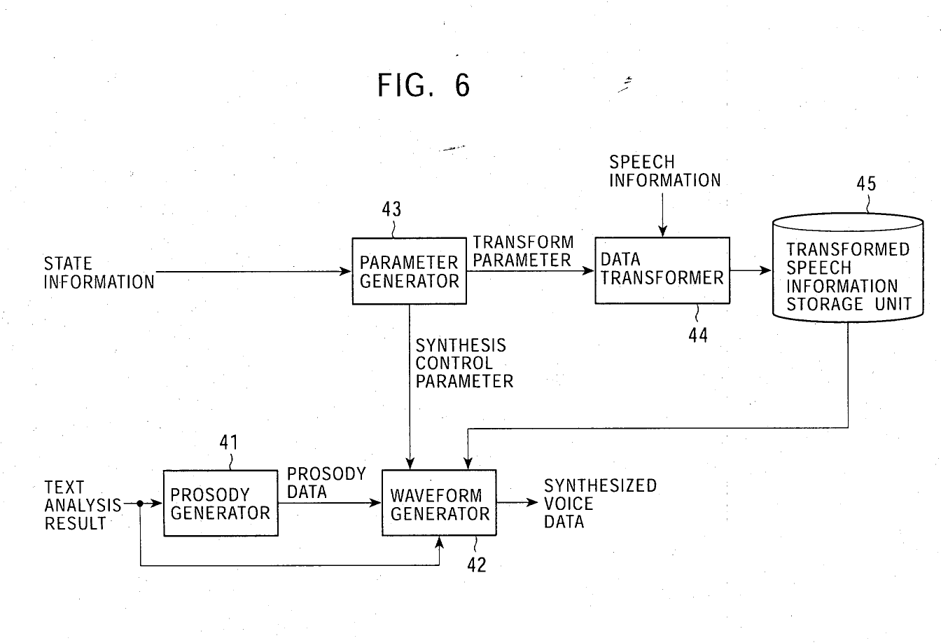

FIG. 6 shows an example of the configuration of the rule-based synthesizer 32 shown in FIG. 5.

The text analysis result obtained by the text analyzer 31 (FIG. 5) is supplied to a prosody generator 41. The prosody generator 41 generates prosody data for specifically controlling the prosody of the synthesized voice on the basis of prosody information indicating, for example, the positions of pauses, accents, intonation, and power, and phoneme information. The prosody data generated by the prosody generator 41 is supplied to a waveform generator 42. The prosody controller 41 generates, as the prosody data, the duration of each phoneme forming the synthesized voice, a periodic pattern signal indicating a time-varying pattern of a pitch period of the synthesized voice, and a power pattern signal indicating a time-varying power pattern of the synthesized voice.

As described above, in addition to the prosody data, the text analysis result obtained by the text analyzer 31 (FIG. 5) is supplied to the waveform generator 42. Also, synthesis control parameters are supplied from a parameter generator 43 to the waveform generator 42. In accordance with phoneme information included in the text analysis result, the waveform generator 42 reads necessary transformed speech information from a transformed speech information storage unit 45 and performs rule-based speech synthesis using the transformed speech information, thus generating a synthesized voice. When performing rule-based speech synthesis, the waveform generator 42 controls the prosody and the tone of the synthesized voice by adjusting the waveform of the synthesized voice data on the basis of the prosody data from the prosody generator 41 and the synthesis control parameters from the parameter generator 43. The waveform generator 42 outputs the finally obtained synthesized voice data.

The state information is supplied from the model storage unit 51 (FIG. 3) to the parameter generator 43. On the basis of an emotion model among the state information, the parameter generator 43 generates the synthesis control parameters for controlling rule-based speech synthesis by the waveform generator 42 and transform parameters for transforming the speech information stored in the speech information storage unit 36 (FIG. 5).

Specifically, the parameter generator 43 stores a transformation table in which values indicating emotional states such as “happiness”, “sadness”, “anger”, “enjoyment”, “excitement”, “sleepiness”, “comfortableness”, and “discomfort” as emotion models (hereinafter referred to as emotion model values if necessary) are associated with the synthesis control parameters and the transform parameters. Using the transformation table, the parameter generator 43 outputs the synthesis control parameters and the transform parameters, which are associated with the values of the emotion models among the state information from the model storage unit 51.

The transformation table stored in the parameter generator 43 is formed such that the emotion model values are associated with the synthesis control parameters and the transform parameters so that a synthesized voice with a tone indicating the emotional state of the pet robot can be generated. The manner in which the emotion model values are associated with the synthesis control parameters and the transform parameters can be determined by, for example, simulation.

Using the transformation model, the synthesis control parameters and the transform parameters are generated from the emotion model values. Alternatively, the synthesis control parameters and the transform parameters can be generated by the following method.

Specifically, for example, Pₙ represents an emotion model value of an emotion #n, Qᵢ represents a synthesis control parameter or transform parameter, and f_{i,n}( ) represents a predetermined function. The synthesis control parameter or transform parameter Qᵢ can be computed by calculating the equation Qᵢ=Σf_{i,n}(Pₙ) where Σ represents a summation over a variable n.

In the above case, the transformation table in which all the emotion model values for states, such as “happiness”, “sadness”, “anger”, and “enjoyment”, are taken into consideration is used. Alternatively, for example, the following simplified transformation table can be used.

Specifically, the emotional states are classified into a few categories, e.g., “normal”, “sadness”, “anger”, and “enjoyment”, and an emotion number, which is a unique number, is assigned to each emotion. In other words, for example, the emotion numbers 0, 1, 2, 3, and the like are assigned to “normal” “sadness”, “anger”, and “enjoyment”. A transformation table in which the emotion numbers are associated with the synthesis control parameters and the transform parameters is created. When using the transformation table, it is necessary to classify the emotional states into “happiness”, “sadness”, “anger”, and “enjoyment” depending on the emotion model values. This can be performed in the following manner. Specifically, for example, given a plurality of emotion model values, when the difference between the largest emotion model value and the second largest emotion model value is greater than or equal to a predetermined threshold, that emotion is classified as the emotional state corresponding to the largest emotion model value. Otherwise, that emotion is classified as the “normal” state.

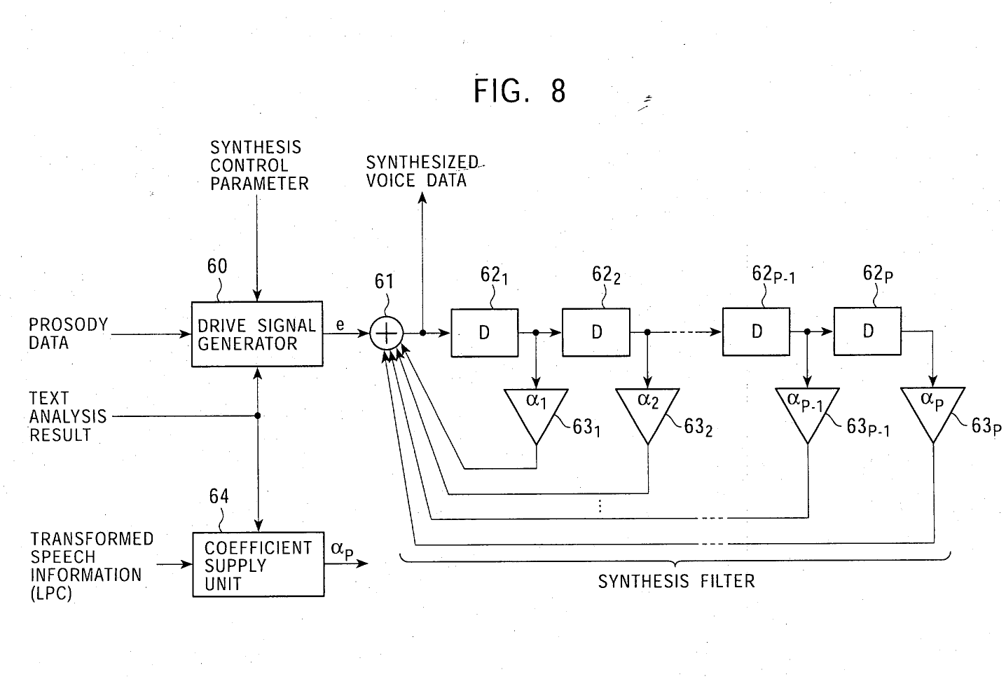

The synthesis control parameters generated by the parameter generator 43 include, for example, a parameter for adjusting the volume balance of each sound, such as a voiced sound, an unvoiced fricative, and an affricate, a parameter for controlling the amount of the amplitude fluctuation of an output signal of a driving signal generator 60 (FIG. 8), described below, which is used as a sound source for the waveform generator 42, and a parameter influencing the tone of the synthesized voice, such as a parameter for controlling the frequency of the sound source.

The transform parameters generated by the parameter generator 43 are used to transform the speech information in the speech information storage unit 36 (FIG. 5), such as changing the characteristics of the waveform data forming the synthesized voice.

The synthesis control parameters generated by the parameter generator 43 are supplied to the waveform generator 42, and the transform parameters are supplied to a data transformer 44. The data transformer 44 reads the speech information from the speech information storage unit 36 and transforms the speech information in accordance with the transform parameters. Accordingly, the data transformer 44 generates transformed speech information, which is used as speech information for changing the characteristics of the waveform data forming the synthesized voice, and supplies the transformed speech information to the transformed speech information storage unit 45. The transformed speech information storage unit 45 stores the transformed speech information supplied from the data transformer 44. If necessary, the transformed speech information is read by the waveform generator 44.

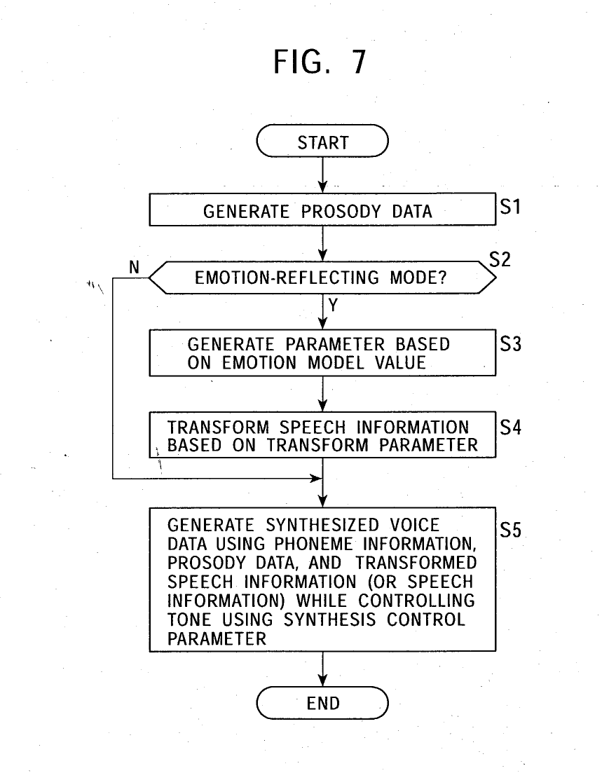

Referring to a flowchart of FIG. 7, a process performed by the rule-based synthesizer 32 shown in FIG. 6 will now be described.

The text analysis result output by the text analyzer 31 shown in FIG. 5 is supplied to the prosody generator 41 and the waveform generator 42. The state information output by the model storage unit 51 shown in FIG. 5 is supplied to the parameter generator 43.

When the prosody generator 41 receives the text analysis result, in step S1, the prosody generator 41 generates prosody data, such as the duration of each phoneme indicated by phoneme information included in the text analysis result, the periodic pattern signal, and the power pattern signal, supplies the prosody data to the waveform generator, and proceeds to step S2.

Subsequently, in step S2, the parameter generator 43 determines whether or not the robot is in an emotion-reflecting mode. Specifically, in this embodiment, either one of the emotion-reflecting mode in which a synthesized voice with an emotion-reflected tone is output and a non-emotion-reflecting mode in which a synthesized voice with a tone in which an emotion is not reflected is output can be preset. In step S2, it is determined whether the mode of the robot is the emotion-reflecting mode.

Alternatively, instead of providing the emotion-reflecting mode and the non-emotion-reflecting mode, the robot can be set to always output emotion-reflected synthesized voices.

If it is determined in step S2 that the robot is not in the emotion-reflecting mode, steps S3 and S4 are skipped. In step S5, the waveform generator 42 generates a synthesized voice, and the process is terminated.

Specifically, if the robot is not in the emotion-reflecting mode, the parameter generator 43 performs no particular processing. Thus, the parameter generator 43 generates no synthesis control parameter nor transform parameter.

As a result, the waveform generator 42 reads the speech information stored in the speech information storage unit 36 (FIG. 5) via the data transformer 44 and the transformed speech information storage unit 45. Using the speech information and default synthesis control parameters, the waveform generator 42 performs speech synthesis processing while controlling the prosody in accordance with the prosody data from the prosody generator 41. Thus, the waveform generator 42 generates synthesized voice data with a default tone.

In contrast, if it is determined in step S2 that the robot is in the emotion-reflecting mode, in step S3, the parameter generator 43 generates the synthesis control parameters and the transform parameters on the basis of an emotion model among the state information from the model storage unit 51. The synthesis control parameters are supplied to the waveform generator 42, and the transform parameters are supplied to the data transformer 44.

Subsequently, in step S4, the data transformer 44 transforms the speech information stored in the speech information storage unit 36 (FIG. 5) in accordance with the transform parameters from the parameter generator 43. The data transformer 44 supplies and stores the resulting transformed speech information in the transformed speech information storage unit 45.

In step S5, the waveform generator 42 generates a synthesized voice, and the process is terminated.

Specifically, in this case, the waveform generator 42 reads necessary information from among the speech information stored in the transformed speech information storage unit 45. Using the transformed speech information and the synthesis control parameters supplied from the parameter generator 43, the waveform generator 42 performs speech synthesis processing while controlling the prosody in accordance with the prosody data from the prosody generator 41. Accordingly, the waveform generator 42 generates synthesized voice data with a tone corresponding to the emotional state of the robot.

As described above, the synthesis control parameters and the transform parameters are generated on the basis of the emotion model value. Speech synthesis is performed using the transformed speech information generated by transforming the speech information on the basis of the synthesis control parameters and the transform parameters. Accordingly, an emotionally expressive synthesized voice with a controlled tone in which, for example, the frequency characteristics and the volume balance are controlled, can be generated.

FIG. 8 shows an example of the configuration of the waveform generator 42 shown in FIG. 6 when the speech information stored in the speech information storage unit 36 (FIG. 5) is, for example, linear prediction coefficients (LPC) which are used as speech feature parameters.

The linear prediction coefficients are generated by performing so-called linear prediction analysis such as solving the Yule-Walker equation using an auto-correlation coefficient computed from the speech waveform data. Concerning the linear prediction analysis, sₙ represents (the sample value of) an audio signal at the current time n, and sₙ₋₁, sₙ₋₂, . . . , s_{n-P} represent P past sample values adjacent to sₙ. It is assumed that a linear combination expressed by the following equation holds true:

sₙ+α₁sₙ₋₁+α₂sₙ₋₂+ . . . +α_{P}s_{n-P}=eₙ (1)

A prediction value (linear prediction value) sₙ′ of the sample value sₙ at the current time n is linearly predicted using the P past sample values sₙ₋₁, sₙ₋₂, . . . , s_{n-P} in accordance with the following equation:

sₙ′=−(α₁sₙ₋₁+α₂sₙ₋₂+ . . . +α_{P}s_{n-P}) (2)

A linear prediction coefficient α_{P} for minimizing the square error between the actual sample value sₙ and the linear prediction value sₙ′ is computed.

In equation (1), {eₙ} ( . . . , eₙ₋₁, eₙ, eₙ₊₁, . . . ) is a non-correlated random variable whose average is 0 and whose variance is σ².

From equation (1), the sample value sₙ can be expressed by:

sₙ=eₙ−(α₁sₙ₋₁+α₂sₙ₋₂+ . . . +α_{P}s_{n-P}) (3)

With the Z-transform of equation (3), the following equation holds true:

S=E/(1+α₁z⁻¹+α₂z⁻²+ . . . +α_{P}z^{-P}) (4)

where S and E represent the Z-transform of sₙ and eₙ in equation (3).

From equation (1) and (2), en can be expressed by:

eₙ=sₙ−sₙ′ (5)

where eₙ is referred to as the residual signal between the actual sample value sₙ and the linear prediction value sₙ′.

From equation (4), the linear prediction coefficient α_{P} is used as a tap coefficient of an IIR (Infinite Impulse Response) filter, and the residual signal eₙ is used as a driving signal (input signal) for the IIR filter. Accordingly, the speech signal sₙ can be computed.

The waveform generator 42 shown in FIG. 8 performs speech synthesis for generating a speech signal in accordance with equation (4).

Specifically, the driving signal generator 60 generates and outputs the residual signal, which becomes the driving signal.

The prosody data, the text analysis result, and the synthesis control parameters are supplied to the driving signal generator 60. In accordance with the prosody data, the text analysis result, and the synthesis control parameters, the driving signal generator 60 superimposes a periodic impulse whose period (frequency) and amplitude are controlled on a signal such as white noise, thus generating a driving signal for giving the corresponding prosody, phoneme, and tone (voice quality) to the synthesized voice. The periodic impulse mainly contributes to generation of a voiced sound, whereas the signal such as white noise mainly contributes to generation of an unvoiced sound.

In FIG. 8, an adder 61, P delay circuits (D) 62₁ to 62_{P}, and P multipliers 63₁ to 63_{P} form the IIR filter functioning as a synthesis filter for speech synthesis. The IIR filter uses the driving signal from the driving signal generator 60 as the sound source and generates synthesized voice data.

Specifically, the residual signal (driving signal) output from the driving signal generator 60 is supplied through the adder 61 to the delay circuit 62₁. The delay circuit 62_{P} delays an input signal input thereto by one sample of the residual signal and outputs the delayed signal to a subsequent delay circuit 62_{P+1} and the computing unit 63_{P}. The multiplier 63_{P} multiplies the output of the delay circuit 62_{P} by the linear prediction coefficient α_{P}, which is set therefor, and outputs the product to the adder 61.

The adder 61 adds all the outputs of the multipliers 63₁ to 63_{P} and the residual signal e and supplies the sum to the delay circuit 62₁. Also, the adder 61 outputs the sum as the speech synthesis result (synthesized voice data).

A coefficient supply unit 64 reads, from the transformed speech information storage unit 45, linear prediction coefficients α₁, α₂, . . . , α_{P}, which are used as necessary transformed speech information depending on the phoneme included in the text analysis result and sets the linear prediction coefficients α₁, α₂, . . . , α_{P} to the multipliers 63₁ to 63_{P}, respectively.

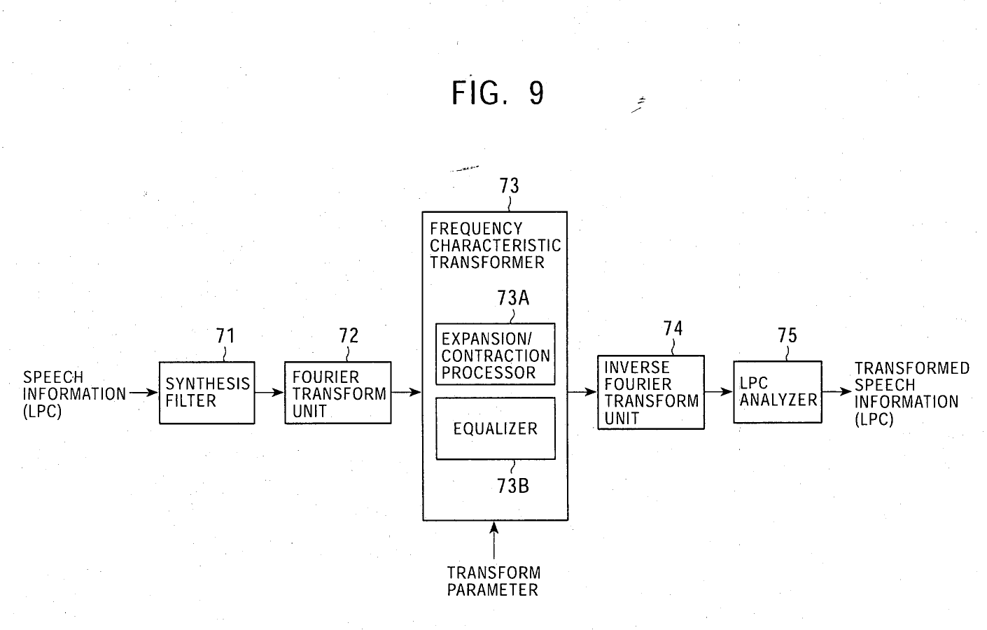

FIG. 9 shows an example of the configuration of the data transformer 44 shown in FIG. 6 when the speech information stored in the speech information storage unit 36 (FIG. 5), includes, for example, linear prediction coefficients (LPC) used as speech feature parameters.

The linear prediction coefficients, which are the speech information stored in the speech information storage unit 36, are supplied to a synthesis filter 71. The synthesis filter 71 is an IIR filter similar to the synthesis filter formed by the adder 61, P delay circuits (D) 62₁ to 62_{P}, and P multipliers 63₁ to 63_{P} shown in FIG. 8. The synthesis filter 71 uses the linear prediction coefficients as tap coefficients and an impulse as a driving signal and performs filtering, thus transforming the linear prediction coefficients into speech data (waveform data in the time domain). The speech data is supplied to a Fourier transform unit 72.

The Fourier transform unit 72 performs the Fourier transform of the speech data from the synthesis filter 71 and computes a signal in the frequency domain, that is, a spectrum, and supplies the signal or the spectrum to a frequency characteristic transformer 73.

Accordingly, the synthesis filter 71 and the Fourier transform unit 72 transform the linear prediction coefficients α₁, α₂, . . . , α_{P} into a spectrum F(θ) Alternatively, the transformation of the linear prediction coefficients α₁, α₂, . . . , α_{P} into the spectrum F(θ) can be performed by changing θ from 0 to π in accordance with the following equation:

F(θ)=1/|1+α₁z⁻¹+α₂z⁻²+ . . . +α_{P}z^{-P}|² z=e^{-jθ} (6)

where θ represents each frequency.

The transform parameters output from the parameter generator 43 (FIG. 6) are supplied to the frequency characteristic transformer 73. By transforming the spectrum from the Fourier transform unit 72 in accordance with the transform parameters, the frequency characteristic transformer 73 changes the frequency characteristics of the speech data (waveform data) obtained from the linear prediction coefficients.

In the embodiment shown in FIG. 9, the frequency characteristic transformer 73 is formed by an expansion/contraction processor 73A and an equalizer 73B.

The expansion/contraction processor 73 expands/contracts the spectrum F(O) supplied from the Fourier transform unit 72 in the frequency axis direction. In other words, the expansion/contraction processor 73A calculates equation (6) by replacing θ by Δθ where Δ represents an expansion/contraction parameter and computes a spectrum F(Δθ) which is expanded/contracted in the frequency axis direction.

In this case, the expansion/contraction parameter Δ is the transform parameter. The expansion/contraction parameter Δ is, for example, a value in the range from 0.5 to 2.0.

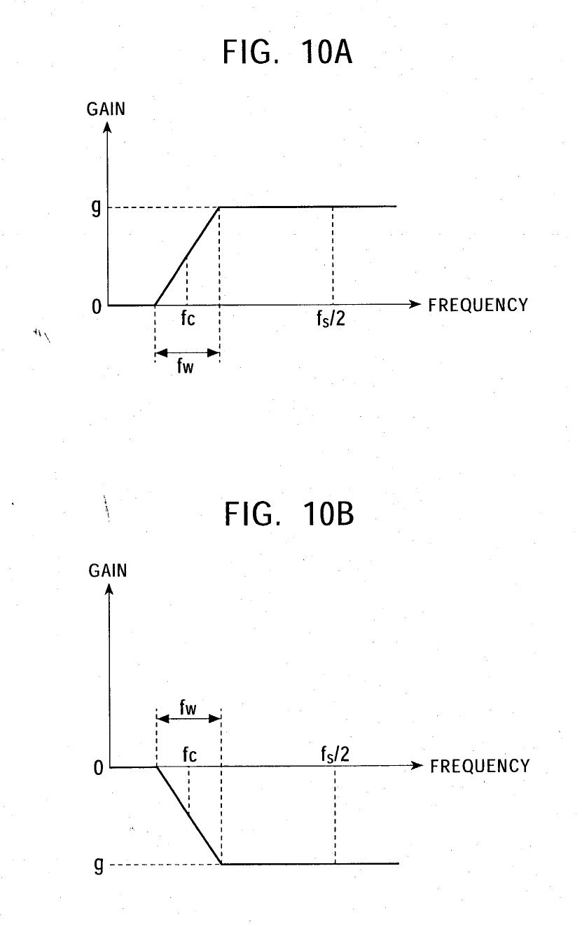

The equalizer 73B equalizes the spectrum F(θ) supplied from the Fourier transform unit 72 and enhances or suppresses high frequencies. In other words, the equalizer 73B subjects the spectrum F(θ) to high frequency emphasis filtering shown in FIG. 10A or high frequency suppressing filtering shown in FIG. 10B and computes the spectrum whose frequency characteristics are changed.

In FIG. 10, g represents gain, f_{c} represents a cutoff frequency, f_{w} represents an attenuation width, and fₛ represents a sampling frequency of the speech data (speech data output from the synthesis filter 71). Of these values, the gain g, the cutoff frequency f_{c} and the attenuation width f_{w} are the transform parameters.

In general, when high frequency emphasis filtering shown in FIG. 10A is performed, the tone of the synthesized voice becomes hard. When high frequency suppressing filtering shown in FIG. 10B is performed, the tone of the synthesized voice becomes soft.

Alternatively, the frequency characteristic transformer 73 can smooth the spectrum by, for example, performing n-degree averaging filtering or by computing a cepstrum coefficient and performing littering.

The spectrum whose frequency characteristics are changed by the frequency characteristic transformer 73 is supplied to an inverse Fourier transform unit 74. The inverse Fourier transform unit 74 performs the inverse Fourier transform of the spectrum from the frequency characteristic transformer 73 to compute a signal in the time domain, that is, speech data (waveform data), and supplies the signal to an LPC analyzer 75.

The LPC analyzer 75 computes a linear prediction coefficient by performing linear prediction analysis of the speech data from the inverse Fourier transform unit 74 and supplies and stores the linear prediction coefficient as the transformed speech information in the transformed speech information storage unit 45 (FIG. 6).

Although the linear prediction coefficients are used as the speech feature parameters in this case, alternatively cepstrum coefficients and line spectrum pairs can be employed.

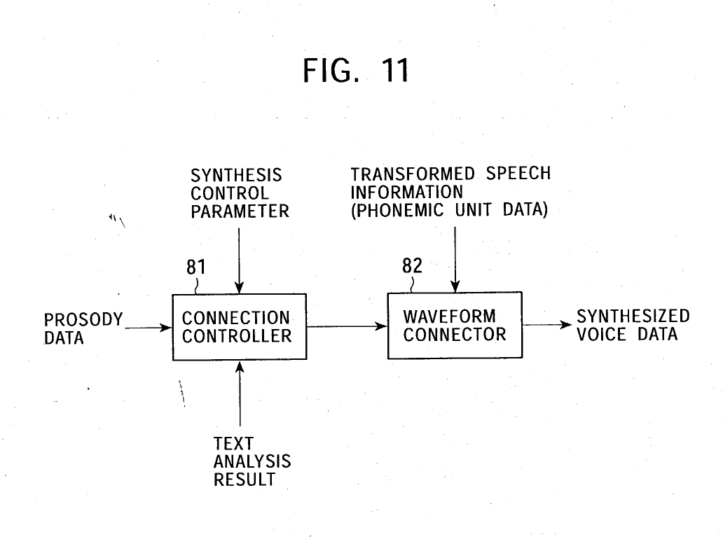

FIG. 11 shows an example of the configuration of the waveform generator 42 shown in FIG. 6 when the speech information stored in the speech information storage unit 36 (FIG. 5) includes, for example, phonemic unit data used as speech data (waveform data).

The prosody data, the synthesis control parameters, and the text analysis result are supplied to a connection controller 81. In accordance with the prosody data, the synthesis control parameters, and the text analysis result, the connection controller 81 determines phonemic unit data to be connected to generate a synthesized voice and a waveform processing method or adjusting method (for example, the amplitude of a waveform) and controls a waveform connector 82.

Under the control of the connection controller 81, the waveform connector 82 reads necessary phonemic unit data, which is transformed speech information, from the transformed speech information storage unit 45. Similarly, under the control of the connection controller 81, the waveform connector 82 adjusts and connects the waveforms of the read phonemic unit data. Accordingly, the waveform connector 82 generates and outputs synthesized voice data having the prosody, tone, and phoneme corresponding to the prosody data, the synthesis control parameters, and the text analysis result.

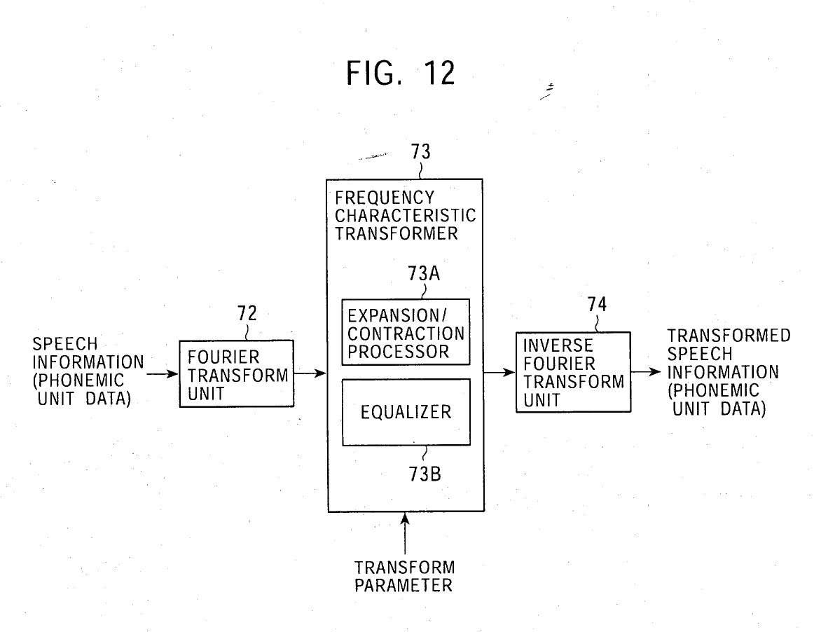

FIG. 12 shows an example of the configuration of the data transformer 44 shown in FIG. 6 when the speech information stored in the speech information storage unit 36 (FIG. 5) is speech data (waveform data). In the drawing, the same reference numerals are given to components corresponding to those in FIG. 9, and repeated descriptions of the common portions are omitted. In other words, the data transformer 44 shown in FIG. 12 is arranged similarly to that in FIG. 9 except for the fact that the synthesis filter 71 and the LPC analyzer 75 are not provided.

In the data transformer 44 shown in FIG. 12, the Fourier transform unit 72 performs the Fourier transform of the speech data, which is the speech information stored in the speech information storage unit 36 (FIG. 5), and supplies the resulting spectrum to the frequency characteristic transformer 73. The frequency characteristic transformer 73 transforms the frequency characteristics of the spectrum from the Fourier transform unit 72 in accordance with the transform parameters and outputs the transformed spectrum to the inverse Fourier transform unit 74. The inverse Fourier transform unit 74 performs the inverse Fourier transform of the spectrum from the frequency characteristic transformer 73 into speech data and supplies and stores the speech data as transformed speech information in the transformed speech information storage unit 45 (FIG. 6).

Although there have been described herein cases in which the present invention is applied to the entertainment robot (robot as a pseudo pet), the present invention is not limited to these cases. For example, the present invention is widely applicable to various systems having speech synthesis apparatuses. Also, the present invention is applicable not only to real-world robots but also to virtual robots displayed on a display such as a liquid crystal display.

Although it has been described in the present embodiment that a series of the above-described processes is performed by the CPU 10A by executing a program, the series of processes can be performed by dedicated hardware.

The program can be stored in advance in the memory 10B (FIG. 2). Alternatively, the program can be temporarily or permanently stored (recorded) in a removable recording medium such as a floppy disk, a CD-ROM (Compact Disc Read Only Memory), an MO (Magneto optical) disk, a DVD (Digital Versatile Disc), a magnetic disk, or a semiconductor memory. The removable recording medium can be provided as so-called package software, and the software can be installed in the robot (memory 10B).

Alternatively, the program can be transmitted wirelessly from a download site via a digital broadcasting satellite, or the program can be transmitted using wires through a network such as a LAN (Local Area Network) or the Internet. The transmitted program can be installed in the memory 10B.

In this case, when the version of the program is upgraded, the upgraded program can be easily installed in the memory 10B.

In the description, processing steps for writing the program that causes the CPU 10A to perform various processes are not required to be processed in time series in accordance with the order described in the flowchart. Steps which are performed in parallel with one other or which are performed individually (for example, parallel processing or processing by an object) are also included.

The program can be processed by a single CPU. Alternatively, the program can be processed by a plurality of CPUs in a decentralized environment.

The speech synthesizer 55 shown in FIG. 5 can be realized by dedicated hardware or by software. When the speech synthesizer 55 is realized by software, a program constructing that software is installed into a general-purpose computer.

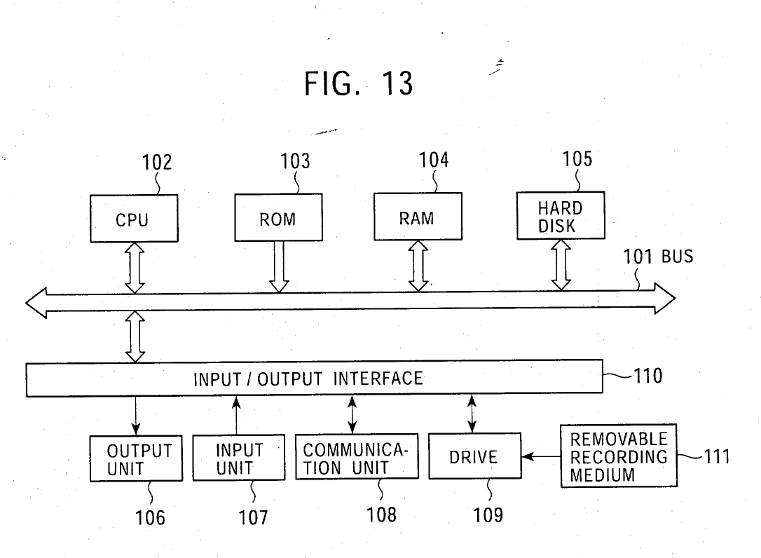

FIG. 13 shows an example of the configuration of an embodiment of a computer into which a program for realizing the speech synthesizer 55 is installed.

The program can be pre-recorded in a hard disk 105 or a ROM 103, which is a built-in recording medium included in the computer.

Alternatively, the program can be temporarily or permanently stored (recorded) in a removable recording medium 111, such as a floppy disk, a CD-ROM, an MO disk, a DVD, a magnetic disk, or a semiconductor memory. The removable recording medium 111 can be provided as so-called package software.

The program can be installed from the above-described removable recording medium 111 into the computer Alternatively, the program can be wirelessly transferred from a download site to the computer via a digital broadcasting satellite or can be transferred using wires via a network such as a LAN (Local Area Network) and the Internet. In the computer, the transmitted program is received by a communication unit 108 and installed in the built-in hard disk 105.

The computer includes a CPU (Central Processing Unit) 102. An input/output interface 110 is connected via a bus 101 to the CPU 102. When an input unit 107 formed by a keyboard, a mouse, and a microphone is operated by a user and a command is input through the input/output interface 110 to the CPU 102, the CPU 102 executes a program stored in the ROM (Read Only Memory) 103 in accordance with the command. Alternatively, the CPU 102 loads a program stored in the hard disk 105, a program transferred from a satellite or a network and received by the communication unit 108 and installed in the hard disk 105, a program read from the removable recording medium 111 mounted in a drive 109 and installed in the hard disk 105 into a RAM (Random Access Memory) 104 and executes the program. Accordingly, the CPU 102 performs processing in accordance with the above-described flowchart or processing performed by the configurations shown in the above-described block diagrams. If necessary, the CPU 102 outputs the processing result via the input/output interface 110 from an output unit 106 formed by an LCD (Liquid CryStal Display) and a speaker or sends the processing result from the communication unit 108, and the CPU 2 records the processing result in the hard disk 105.

Although the tone of a synthesized voice is changed on the basis of an emotional state in this embodiment, alternatively, for example, the prosody of the synthesized voice can also be changed on the basis of the emotional state. The prosody of the synthesized voice can be changed by controlling, for example, the time-varying pattern (periodic pattern) of a pitch period of the synthesized voice and the time-varying pattern (power pattern) of power of the synthesized voice on the basis of an emotion model.

Although a synthesized voice is generated from text (including text having Chinese characters and Japanese syllabary characters) in this embodiment, a synthesized voice can also be generated from phonetic alphabet.

### INDUSTRIAL APPLICABILITY

As described above, according to the present invention, among predetermined information, tone-influencing information which influences the tone of a synthesized voice is generated on the basis of externally-supplied state information indicating an emotional state. Using the tone-influencing information, a tone-controlled synthesized voice is generated. By generating a synthesized voice with a tone changed in accordance with an emotional state, an emotionally expressive synthesized voice can be generated.

1. A speech synthesis apparatus for performing speech synthesis using predetermined information, comprising:
tone-influencing information generating means for generating, among the predetermined information, tone-influencing information for influencing the tone of a synthesized voice on the basis of externally-supplied state information indicating an emotional state; and
speech synthesis means for generating the synthesized voice with a tone controlled using the tone-influencing information.

2. A speech synthesis apparatus according to claim 1, wherein the tone-influencing information generating means comprises:
transform parameter generating means for generating a transform parameter for transforming the tone-influencing information so as to change the characteristics of waveform data forming the synthesized voice on the basis of the emotional state; and
tone-influencing information transforming means for transforming the tone-influencing information on the basis of the transform parameter.

3. A speech synthesis apparatus according to claim 2, wherein the tone-influencing information is the waveform data in predetermined units to be connected to generate the synthesized voice.

4. A speech synthesis apparatus according to claim 2, wherein the tone-influencing information is a feature parameter extracted from the waveform data.

5. A speech synthesis apparatus according to claim 1, wherein the speech synthesis means performs rule-based speech synthesis, and
the tone-influencing information is a synthesis control parameter for controlling the rule-based speech synthesis.

6. A speech synthesis apparatus according to claim 5, wherein the synthesis control parameter controls the volume balance, the amount of the amplitude fluctuation of a sound source, or the frequency of the sound source.

7. A speech synthesis apparatus according to claim 1, wherein the speech synthesis means generates the synthesized voice whose frequency characteristics or volume balance is controlled.

8. A speech synthesis method for performing speech synthesis using predetermined information, comprising:
a tone-influencing information generating step of generating, among the predetermined information, tone-influencing information for influencing the tone of a synthesized voice on the basis of externally-supplied state information indicating an emotional state; and
a speech synthesis step of generating the synthesized voice with a tone controlled using the tone-influencing information.

9. A program for causing a computer to perform speech synthesis processing for performing speech synthesis using predetermined information, comprising:
a tone-influencing information generating step of generating, among the predetermined information, tone-influencing information for influencing the tone of a synthesized voice on the basis of externally-supplied state information indicating an emotional state; and
a speech synthesis step of generating the synthesized voice with a tone controlled using the tone-influencing information.

10. A recording medium having recorded therein a program for causing a computer to perform speech synthesis processing for performing speech synthesis using predetermined information, the program comprising:
a tone-influencing information generating step of generating, among the predetermined information, tone-influencing information for influencing the tone of a synthesized voice on the basis of externally-supplied state information indicating an emotional state; and
a speech synthesis step of generating the synthesized voice with a tone controlled using the tone-influencing information.
